(19) United States
(12) Patent Application Publication
(10) Pub. No.: US 2002/0129978 A1
(43) Pub. Date: Sep. 19, 2002

(54) Winged scale for body fat and weight

(76) Inventors: James G. Montagnino, St. Charles, IL (US); Anson Wong, Glendale Heights, IL (US); Ricardo Murguia, Berwyn, IL (US); Eiichi Watanabe, Kameda-Machi (JP); Toshihiko Machiyama, Osaka (JP)

Correspondence Address: Kevin M. Curran, Kramer Levin Naftalis & Frankel LLP, 919 Third Avenue, New York, NY, 10022, US

(21) Appl. No.: 09/809,848

(22) Filed: Mar. 16, 2001

(51) Int. Cl. G01G 21/00

(52) U.S. Cl. 177/126

(57) ABSTRACT

A winged scale for measurement of body weight and determination of body fat content includes a scale structure, two wings movably attached to the scale structure by a positioning mechanism, a weighing device, an impedance measuring device, an input device, a data processing device, and a data output device. The two wings comprise right and left wings respectively having right and left electrodes to electrically contact a user's barefoot soles, wherein the right and left electrodes are spread apart as the wings move to an open position. The impedance measuring device measures an electrical impedance of the user through the soles contacting the electrodes. The input device permits entry of the user's personal physical data. The data processing device determines the user's body fat content, based on measured impedance, measured weight, and entered personal data. The data output device may output visually and/or audibly the measured and determined data.

### FIELD OF THE INVENTION

The present invention relates to a winged scale for measurement of body weight and determination of body fat content

### BACKGROUND INFORMATION

Numerous techniques for measuring a person's weight and determining the person's body fat content have been proposed and embodied as body fat and weight scales. One such technique is described in Japanese Patent Publication No. Hei 5(1993)-49050, which describes a body fat scale (also called an adipometer) comprising a weighing platform; an electronic body weight measuring device; and two electrodes electrically connected to an impedance measuring device and adapted to contact the soles of a user's bare feet. Through use of a keypad, the user may input personal information, such as age and gender, necessary for accurate determination of weight of body fat from the body weight and impedance of one's body.

The two electrodes are integrally built in the weighing platform so as to be electrically insulated from each other. Optimally, an electric current approximately will pass from the first foot, up the entire first leg, over the groin, down the entire second leg, and through the second foot. This body fat scale is designed to incorporate the electrodes on the weighing platform so that both weight and electrical impedance can be measured automatically with the user's simple mounting of the weighing platform with bare feet.

In this conventional body fat scale, one of the two electrodes is on the right side of the scale, the other on the left, corresponding to the right and left feet, and the two electrodes are fixedly arranged on and integrated with the weighing platform. Each electrode typically may be at least 5 cm wide to enable adequate contact with a foot sole, which easily may be 9 cm wide. Because most scales are not much wider than 30 cm, there often will be only 10 cm or so between the insides of the user's feet when the feet are squarely placed on the scale platform. With this arrangement, the limited space between the two electrodes requires the user to place his or her feet close to each other. Accordingly, the inner thighs of the user are liable to contact each other, depending on the user's physical constitution.

When the user's inner thighs contact each other during the measurement of electrical impedance, the electric current passing from the right electrode to the left electrode may be short-circuited at the point of contact between the thighs. Two common routes by which the electric current may pass may be represented as a parallel circuit, a first route having the current pass through the groin, as described above, and a second route having the current short-circuit at the thighs. The second route yields an inaccurate result by rendering an impedance lower than that by the first route. For this reason, with this conventional arrangement of two electrodes built into the platform and being arranged with a limited space therebetween, the determined body fat result may be in error by tens of percents.

Consequently, it is not surprising that a user standing with the right and left feet spread apart to some extent improves the accuracy of measurement of the impedance. In addition to reducing the chances that the user's thighs contact each other, this improvement apparently arises because spreading apart one's feet produces a balanced posture with little stagger, thus producing little variation in pressure at the joints, thereby stabilizing the impedance and the resulting measurement of the body fat.

Therefore, the impedance should desirably be measured in the standing posture with the right and left feet spreading apart to some extent, necessitating that the electrodes also be spread apart. The weighing platform having two built-in electrodes has the disadvantage, however, that spreading apart the two electrodes involves increasing the size of the entire device, thus increasing the amount of floor space required to store the scale. Because scales for use at home are often found in the bathroom, where floor space is at a minimum, increasing the size of the scale poses a significant commercial disadvantage.

One method proposed to avoid these disadvantages involves a technique having a pair of left and right electrodes separated from a weighing device, so as to measure the weight of fat at higher accuracy. By separating the electrodes from the weighing device, the electrodes may be spread apart easily and according to the height of the user. However, these electrodes are attached to the weighing device by unsightly cords that may dangle and suffer damage if crushed, pinched or pulled. Also, this technique results in three devices, instead of one, making it a bit more cumbersome to handle than one, combined device.

It would therefore be advantageous to have a single scale device combine the ease of use of an integrated body fat and weight scale with the accuracy achieved by spreading apart the electrodes for use in a straddled posture. It would also be desirous that the electrodes easily could be spread apart from a closed position to an open position and likewise easily be returned from the open position to the closed position, so as to minimize the amount of floor space occupied by the scale and the effort required to operate it.

### SUMMARY OF THE INVENTION

The present invention is directed to a winged scale for measurement of body weight and determination of body fat content. A winged scale for measurement of body weight and determination of body fat content according to the present invention may comprise: a weighing device for weighing a user; an impedance measuring device for measuring the electrical impedance across the body of the user; an input device for entering personal data of the user such as gender, age and body height; a data processing device for determining the fat content of the user from the entered personal data, the measured weight and the measured impedance; a data output device for informing the user of the measured weight and determined fat content; a main housing containing the weighing device, the impedance measuring device, the input device, the data processing device, and the data output device; and two wings movably attached to the main housing and having electrodes coupled to the impedance measuring device, the electrodes being attached to the wings so as to contact the user's barefoot soles, and the wings being movable between an open position and a closed position so that the electrodes are exposed when the wings are in the open position.

Each wing is movably attached to the main housing by a positioning mechanism, such as hinges, rails, and links. In the open position, the two wings are arranged on either side of the weighing device, a left wing on the left side and a right wing on the right side. Each wing has an electrode, corresponding to a right electrode and a left electrode. With this arrangement, the electrodes are spaced apart by the width of the weighing device so that the internal portions of the thighs of the user are less likely to contact each other, thereby improving the accuracy of measurement of the body fat. Moreover, the positioning mechanism of the wings may be modified so that in the open position, the wings are suspended slightly above the floor in the absence of weight on them, but the wings then rest directly on the floor as the user steps on the wings to measure the impedance.

The input device may include, for example, a keypad placed on the weighing platform, or possibly an RF or IR remote control, not unlike those typically used with televisions. Voice recognition technology also may be used, such as in a manner similar to that used in many mobile phones. An electronic memory device may be included to store the personal data entered with the input device. Likewise, the input device may permit the storage and differentiation of personal data from multiple users and tracking of data over an extended period of time. The physical characteristics which may be selectively input as the personal data include not only the user's gender, age, body height and crotch height, but also a user's arm length, a length from navel to sole, girth of an arm, girth of thighs, girth of lower thighs, size of a breast, girth of an abdomen, size of a lumbar region, and seating height. Depending on the categories of personal information to be entered, the determination of the body fat content can be modified to account for the corresponding variables to improve the accuracy of the determination.

The data output device may include a visual information output device, such as a display panel, a sound generating device, such as a synthetic voice output device, or both. A digital display panel may include one or more of light emitting diodes (LED), liquid crystals (LCD), and a backlight. The sound generating device may be as simple as a beeping device, or as complicated as a voice synthesizer. Pre-recorded voice messages may be used in place of a voice synthesizer. The pre-recorded voice messages may be combined by the data processing device to create a larger number of voice messages than are pre-recorded.

### BRIEF DESCRIPTION OF THE DRAWINGS

FIG. 1 is a perspective view of a first exemplary embodiment of a winged scale for measurement of body weight and determination of body fat content according to the present invention.

FIGS. 2A-2C are cross sectional side views showing varieties of a positioning mechanism employed in the first exemplary embodiment of the winged scale for measurement of body weight and determination of body fat content according to the present invention.

FIG. 3 is a perspective view of a second exemplary embodiment of the present invention.

FIGS. 4A-4C are cross sectional side views showing varieties of a positioning mechanism employed in the winged scale for measurement of body weight and determination of body fat content of the second exemplary embodiment.

FIG. 5 is a perspective view of a third exemplary embodiment of the present invention.

FIG. 6 is a perspective view of a fourth exemplary embodiment of the present invention.

FIG. 7 is a flowchart illustrating the action of the winged scale for measurement of body weight and determination of body fat content.

FIG. 8 is an enlarged cross sectional view of another variety of a positioning mechanism employed in a fifth exemplary embodiment of the present invention.

Other features and advantages of the present invention will be apparent from the following description of the exemplary embodiments thereof, and from the claims.

### DETAILED DESCRIPTION

A winged scale for measurement of body weight and determination of body fat content according to the present invention will be described in more detail referring to the relevant drawings of embodiments.

### OVERALL ARRANGEMENT

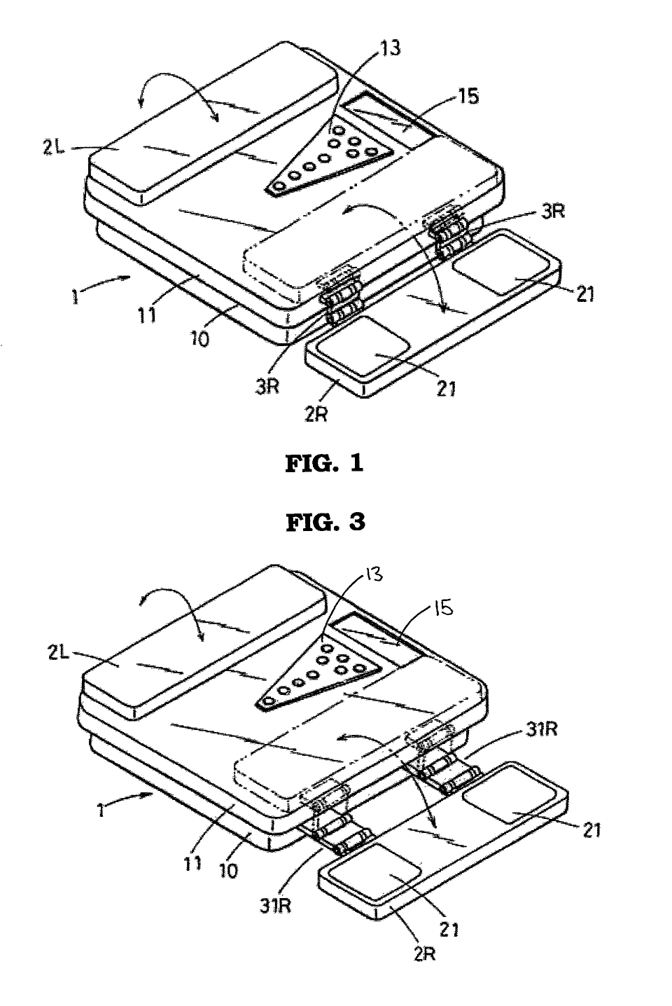

FIG. 1 is a perspective view of a first exemplary embodiment of a winged scale for measurement of body weight and determination of body fat content in accordance with the present invention. The scale of FIG. 1 includes a main housing 1, a right wing 2R movably attached to the main housing 1, and a left wing 2L movably attached to the main housing 1. Also shown are a base 10 of the main housing 1 and a platform 11 having a weighing surface. Not shown but present within the main housing 1 are a weighing device, an impedance measuring device, and a data processing device for determining the fat content of the user. The weighing device may be a load cell, for example, positioned to weigh a user standing on the platform 11. Within the main housing 1, the weighing device and the impedance measuring device may be electronically coupled to the data processing device. Arranged on the platform 11 may be an input device 13 for entry of personal data of the user including gender, age, and height. The platform 11 may also contain a data output device 15, such as a digital display 15 for displaying the measured body weight and the determined fat content.

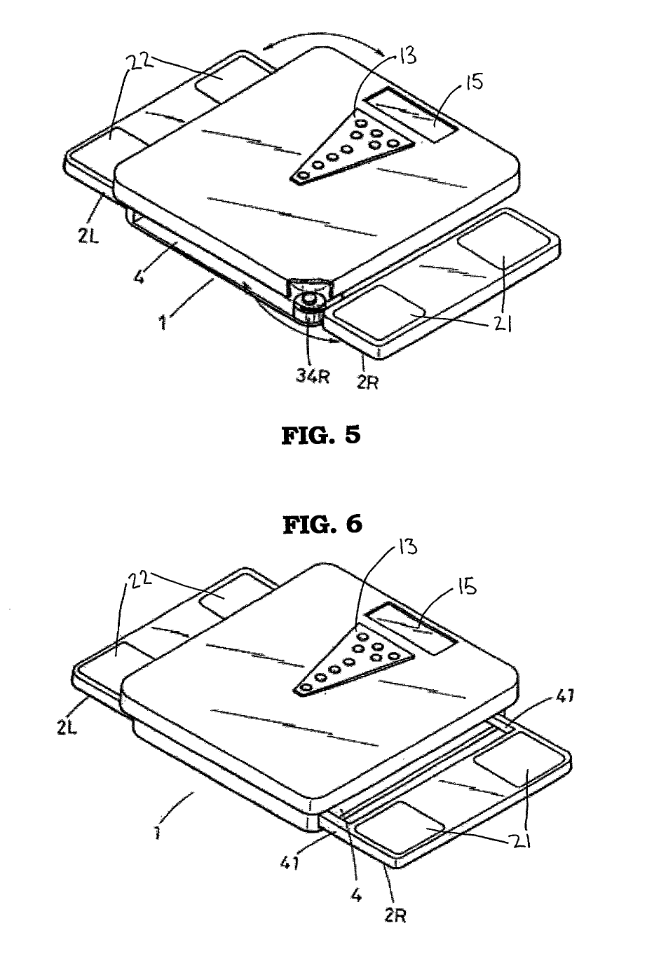

In the embodiment shown in FIG. 1, the platform 11 of the main housing 1 and the right wing 2R are hinged to each other by a first positioning mechanism 3R. The analogous left wing 2L likewise is hinged by first positioning mechanism 3L (not shown) to the left side of the platform 11 on the main housing 1. In contrast to the position of the left wing 2L, the right wing 2R is shown in FIG. 1 as being in the open position, exposing a right foot electrode 21 provided on an inward side of the right wing 2R. Similarly, the left wing 2L includes a left foot electrode 22 on the inward side (shown in FIGS. 5 and 6), which is not visible because the left wing 2L is in the closed position in FIG. 1. The right foot and left foot electrodes 21 and 22 are arranged to electrically contact the soles of the barefoot user. The impedance measuring device is electrically coupled to both the right foot electrode 21 and the left foot electrode 22 by electrical conductors that extend through the positioning mechanisms 3R and 3L and the right and left wings 2R and 2L.

Furthermore, positioning mechanisms 3L and 3R may include internal switches (not shown) that activate the winged scale when the left and right wings 2L and 2R are moved from the closed position to the open position, preparing the winged scale for use. The transition between the closed position and the open position in FIG. 1 is by means of a hinge action denoted by the arrow. Conversely, the internal switches may deactivate the winged scale to conserve power when one or both of the wings 2L and 2R are returned to the closed position. When the wings 2L and 2R are in the open position, the winged scale is ready to measure the weight of and electrical impedance across the user. Insofar as the scale may be used to measure the user's weight alone when the wings 2L and 2R are in the closed position (by standing on the closed wings), a separate power switch may be useful to activate the scale without opening the wings.

The data processing device may include, for example, a microprocessor. The data processing device may determine the body fat content by calculation, matching, or both. A body fat calculation involves substitution of input values for variables having previously assigned coefficients into one or more preprogrammed equations. The data processing device may also match the values of the variables with pre-calculated body fat content values stored in a database (or “look up” on a table) of body fat content values. Similarly, the data processing device may calculate one part of the body fat content determination and match another part of it. The scale may also be programmed to perform other data calculations and comparisons, such as determination of a user's body mass index, which indicates whether the user is below, at or above the desired body composition given the user's gender and height.

### POSITIONING MECHANISMS

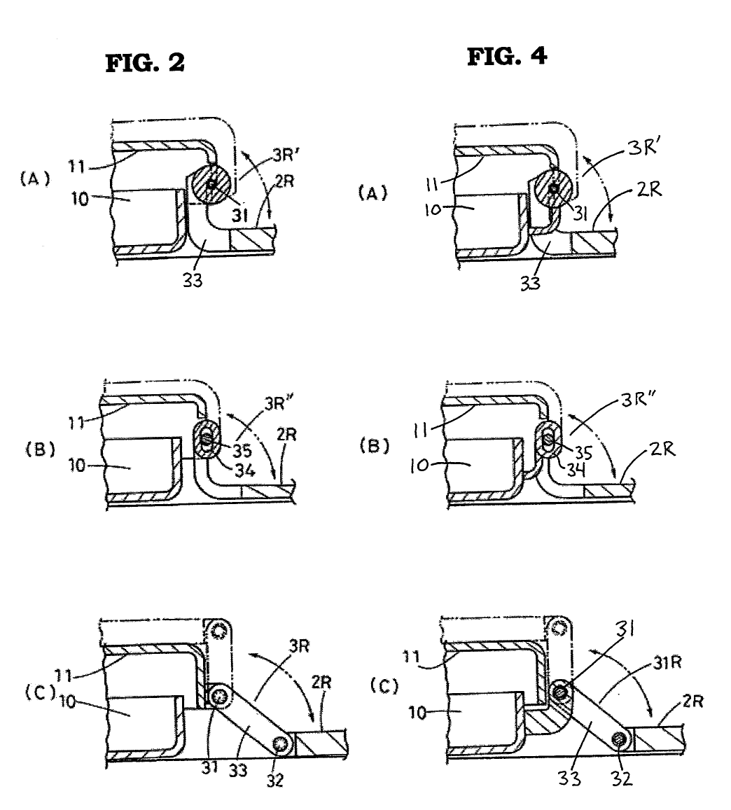

FIGS. 2A-2C are cross sectional side views showing three exemplary positioning mechanisms 3R employed on the right side of the platform 11 of the winged scale for measurement of body weight and determination of body fat content shown in FIG. 1. The positioning mechanisms 3L employed on the left side are preferably similar but are not shown here for simplicity. As shown in FIGS. 2A-2B, the wings 2R rest slightly above the floor while the body weight is being measured, so as not to interfere with the vertical movement of the platform 11 during weighing. But as the user steps on the wings to measure the impedance, the user's weight presses the wings directly against the floor, transferring the load to the floor. When not in use, the right wing 2R can be returned to the closed position, the movement being denoted by the two-dot arrowed arc.

FIG. 2A is a cross sectional side view of a second exemplary positioning mechanism 3R′ on the right side of platform 11. A connecting member 33 is mounted on the right wing 2R about an axial member 31 attached to the platform 11, permitting the right wing 2R to pivot between the open and closed positions, as denoted by the two-dot arrowed arc. FIG. 2B is a cross sectional side view of a third exemplary positioning mechanism 3R″ on the right side of platform 11. The second exemplary positioning mechanism 3R″ includes a connecting slot 34 mounted on the right wing 2R about an axial member 35 provided on the right edge of the platform 11.

FIG. 2C is a cross sectional side view of the first positioning mechanism 3R shown in FIG. 1 which comprises the axial member 31 attached to the platform 11, an axial member 32 attached to the right wing 2R, and a connecting member 33 between axial members 31 and 32. However, when the right wing 2R of FIG. 2C is in the open position, it rests on the floor, potentially altering the measured weight by possibly preventing free vertical movement of the platform 11 by the weight of right wing 2R.

FIG. 3 is a perspective view of a second exemplary embodiment of the winged scale showing a fourth exemplary positioning mechanism 3 IR mounted to the base 10. The positioning mechanism 31 R includes the axial member 31 attached, however, to the base 10, an axial member 32 attached to the right wing 2R, and a connecting member 33 (shown in FIG. 2) between axial members 31 and 32. A similar positioning mechanism 3 1L is provided at the left wing 2L. The positioning mechanism 31R is shown in greater detail in FIG. 4C.

FIGS. 4A-4C are cross sectional side views showing three exemplary positioning mechanisms employed on the right side of the base 10 of the winged scale for measurement of body weight and determination of body fat content shown in FIG. 3. Because the wings 2R and 2L are attached to the base 10 instead of the platform 11, the wings 2R and 2L may rest directly on the floor while the body weight is being measured and not interfere with the vertical movement of the platform 11 during weighing. When not in use, the right wing 2R can be returned to the closed position, the movement being denoted by the two-dot arrowed arc.

FIG. 4A is a cross sectional side view of a fifth exemplary positioning mechanism 3R′, arranged however on the right side of the base 10. As in FIG. 2A, a connecting member 33 is mounted on the right wing 2R about an axial member 31 attached, however, to the base 10, permitting the right wing 2R to move between the open and closed positions, as denoted by the two-dot arrowed arc.

FIG. 4B is a cross sectional side view of a sixth exemplary positioning mechanism 3R″, arranged however on the right side of the base 10. As in FIG. 2B, the sixth exemplary positioning mechanism 3R″ includes a connecting slot 34 mounted on the right wing 2R about an axial member 35 provided, however, on the right edge of the base 10.

FIG. 4C is a cross sectional side view of the fourth positioning mechanism 3 1R shown in FIG. 3 and described above.

As shown in FIGS. 1 to 4, the pivot axes extend substantially in parallel with the weighing surface.

FIG. 5 illustrates a seventh positioning mechanism 34R joined to the right wing 2R by a hinge between the base 10 of the main housing 1 and the right wing 2R, permitting the right wing 2R to pivot between the right side of the scale and into an interior space 4 within the base 10 for storage in the closed position. The main housing 1 has the interior space 4 at both the front provided to accommodate the right wing 2R and at the rear (not shown) to accommodate the left wing 2L. Naturally, either wing 2L or 2R may be arranged to pivot into either interior space 4 when in the closed position. As denoted by the arrows in FIG. 5, the left and right wings 2L and 2R are joined to the main housing 1 so that they can be turned between the open position and the closed position in the space 4. The pivot axes extend substantially vertical to the weighing surface.

The electrical conductors for electrically coupling the impedance measuring device with the right and left foot electrodes 21 and 22 may extend through the interior of the positioning mechanism 34R, as may be the case with any of the positioning mechanisms.

FIG. 6 illustrates a perspective view of a fourth exemplary embodiment of the present invention having the left and right wings 2L and 2R slidably joined to the main housing 1. An eighth positioning mechanism includes arms 41 extending from the wings 2R and 2L into the interior space 4 for sliding between the closed position in the interior space 4 and the open position beyond the main housing 1. The arms 41 may engage a track or rail system (not shown) within the main housing 1 for stability and control. A similar positioning mechanism is provided for the left wing 2L.

The electrical conductors for electrically coupling the impedance measuring device with the right and left foot electrodes 21 and 22 may extend through the interior of the arms 41.

The input panel 13 and the digital display 15 may be mounted on the main housing 1. Alternatively, in addition to the digital display 15, an audible data output device (not shown) such as a synthetic sound emitting device, may be provided for announcing the measured weight and/or determined body fat content.

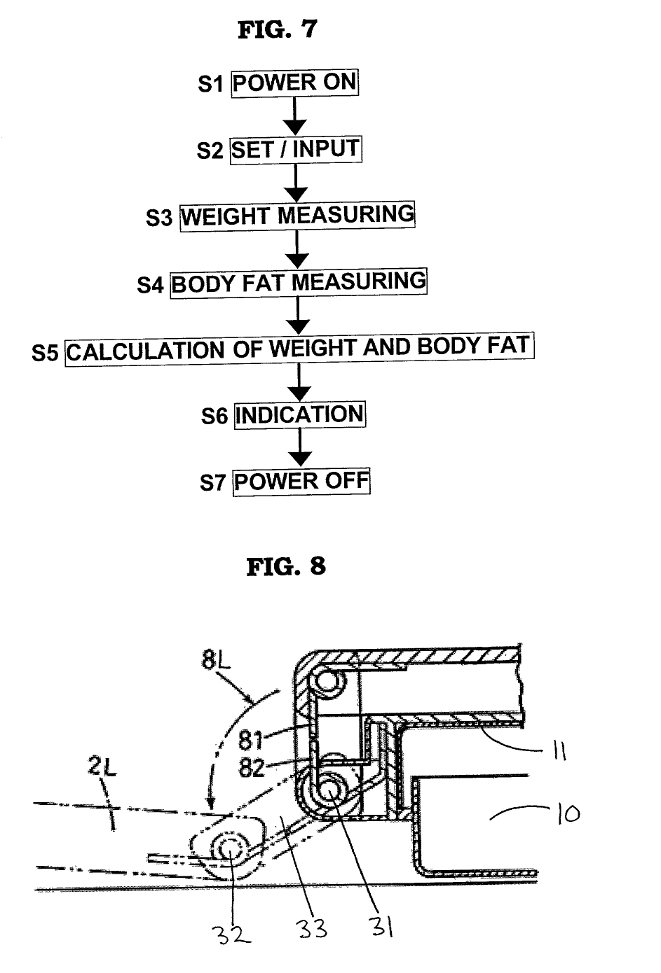

In accordance with the above description of the winged scale for measurement of body weight and determination of body fat content, an exemplary functionality scheme of the winged scale is illustrated as a flowchart in FIG. 7. The flowchart in FIG. 7 is just one of many ways in which such a winged scale may be operated. Variations in the method of operation will be based in part on design parameters within the control of the manufacturer.

As shown in FIG. 7, the method of operation begins with activating the scale by turning it on, shown as Step S1. As mentioned above, there may be a power switch contained within the positioning mechanism that is activated when the wings are in the open position, and/or the main housing 1 may have a separate power switch to actuate the power supply circuit for energization of each component. Depending on the configuration of the winged scale, Step S1 may include moving the wings 2L and 2R from the closed position to the open position to make them available for use.

At Step S2, the user is prompted by the digital display 15 to enter personal data such as the user's gender, height, and age, on the input panel 13. If desired, the personal data may be labeled, stored and retrieved for later use.

After entering the user's personal data, the display 15 prompts the user to step atop the platform 11 for Step S3, wherein the weight of the user is measured by the weighing device, such as a load cell, in the main housing 1.

At Step S4, the user is prompted to step on the wings 2L and 2R that are in the open position, thereby spreading the user's feet and legs apart somewhat. In accordance with known techniques, signals are radiated through the user by the right and left foot electrodes 21 and 22, permitting the impedance across the body of the user to be detected using a four-terminal electrode technique.

Upon determining the electrical impedance of the user's legs, Step S5 includes determining the fat rate, the fat weight, and the obesity index of the user from a known formula using the measured weight, detected impedance and the personal data including the user's gender, height, and age.

At Step S6, the digital display 15 may indicate a variety of data according to how it is programmed, potentially displaying, for example, all the measurements and determinations, including the weight measured in Step S3, and the fat rate, the fat weight, and the obesity index determined in Step S5.

Upon the completion of the measurement, determination and display, Step S7 shuts off the power to the scale, either through a timer device (not shown) programmed to disconnect the power after a specific period of non-use, through switches within the positioning mechanisms as the wings 2L and 2R are returned to the closed position, or through the main switch being deactivated.

Alternatively, as shown in FIG. 8, the scale may include a ninth positioning mechanism 8L similar to the first positioning mechanism 3L. The positioning mechanism 8L includes the axial member 31 attached to the platform 11, the axial member 32 attached to the left wing 2L, and the connecting member 33 between axial members 31 and 32. However, in addition, the positioning mechanism 8L may include springs 81 and 82 for opening and closing actions of the left wing 2L. While not shown, a similar positioning mechanism is provided for the right wing 2R. The positioning mechanism 8L also may include a damper (not shown) for diminishing both the initial speed and the terminal speed of the wing movement.

As shown in FIG. 8, the two springs 81 and 82 are mounted about the axes of axial members 32 and 31, respectively, in the positioning mechanism 8L for urging the left wing 2L in the direction of the open position when in the closed position, and for holding the left wing 2L slightly above the floor when it is in the open position, denoted by the two-dot arrowed arc. This allows the left wing 2L to remain above the floor, as denoted by the two-dot arrowed arc, during the weighing process, hence improving the accuracy of the measurement of the user's weight.

During the measurement of the impedance, the weight of the user presses the left wing 2L in the open position, denoted by the two-dot arrowed arc, down to the floor, while the springs 81 and 82 of the positioning mechanism 8L provide minimal resistance. Accordingly, the impedance across the user can be measured with stability. The positioning mechanism 8L including the two springs 81 and 82 shown in FIG. 8 may also be referred to as a support construction.

Depending on the choice of positioning mechanism, it may be advantageous to include a spring-loaded opening mechanism and a corresponding closure restraint mechanism. The spring-loaded opening mechanism facilitates the opening of the wings to the open position, whereas the closure restraint mechanism maintains the wings in the closed position despite the loaded springs exerting an opening force. Manual closure of the wings resets the spring-loaded opening mechanism and the closure restraint mechanism. Disengaging the closure restraint mechanism causes the spring-loaded opening mechanism to automatically open the wings. The closure restraint mechanism may be disengaged, for example, by depressing a button that releases the springs.

A number of embodiments of the present invention have been described above. Nevertheless, it will be understood that various modifications may be made without departing from the spirit and scope of the invention. Accordingly, other embodiments may be within the scope of the following claims. It is intended that all matter contained in the above description or shown in the accompanying drawings shall be interpreted as illustrative and not in a limiting sense. It is also understood that the following claims are intended to cover all of the generic and specific features of the invention herein described and all statements of the scope of the invention, expressed or implied.

What is claimed is:

1. A scale comprising:
a weighing device;
an impedance measuring device;
at least two electrodes coupled to the impedance measuring device;
a data output device;
a data processing device coupled to the weighing device, to the impedance measuring device, and to the data output device;
a scale structure having a front side, a rear side, a left side and a right side, and containing the weighing device, the impedance measuring device, the data processing device, and the data output device; the scale structure comprising:
a main housing having a weighing platform and a base, and
two housing extension wings,
each housing extension wing being movably attached by a positioning mechanism to the main housing and having at least one of the at least two electrodes arranged for electrical contact with a user's bare feet;
wherein the two housing extension wings may be moved between an open position and a closed position by using the positioning mechanism, the open position being characterized by the two housing extension wings being spread apart.

2. A scale comprising:
weighing means for weighing the weight of a user;
impedance measuring means for measuring the impedance across the body of a user;
data output means for reporting measured, determined or input data;
data processing means for determining characteristics of the user, the data processing means being coupled to the weighing means, the impedance measuring means, and the data output means; and
housing means for containing at least one of the weighing means, the impedance measuring means, the data processing means, and the data output means, the housing means including two wings having at least a pair of electrodes being coupled to the impedance measuring means and arranged for electrical contact with a user's bare feet, the two wings being movable between a closed position and an open position by operation of a positioning mechanism joining each wing to the housing means.

3. The scale of claim 1, wherein the positioning mechanism suspends the two wings in the open position above the floor in the absence of weight on the wings.

4. The scale of claim 1 further comprising an input device communicating with the data processing device and the data output device, wherein the user may enter personal data into the data processing device through operation of the input device.

5. The scale of claim 4, wherein the input device includes one of a keypad on the main housing, voice recognition means, and a remote control.

6. The scale of claim 4 further comprising an electronic memory device coupled to the data processing device and the input device.

7. The scale of claim 1, wherein the positioning mechanism includes a hinge joining each wing to one of the weighing platform and the base on one of the left side and the right side.

8. The scale of claim 7, wherein the hinge is arranged axially along one of the left side and the right side, the closed position is further characterized by the two wings lying folded atop the weighing platform, and the open position is further characterized by the two wings extending unfolded from the one of the left side and the right side.

9. The scale of claim 7, wherein the hinge is arranged axially perpendicular to one of the left side and the right side, the closed position is further characterized by the two wings being rotated into an interior space within the scale structure, and the open position is further characterized by the two wings being rotated out of the interior space to rest along the one of the left side and the right side.

10. The scale of claim 1, wherein the positioning mechanism includes a link joining each wing to one of the weighing platform and the base on one of the left side and the right side.

11. The scale of claim 10, wherein the link is attached radially from an axis of rotation along one of the left side and the right side, the closed position is characterized by the two wings lying folded atop the weighing platform, and the open position is characterized by the two wings extending unfolded from the one of the left side and the right side.

12. The scale of claim 1, wherein the positioning mechanism includes a track joining each wing to the scale structure on one of the left side and the right side.

13. The scale of claim 12, wherein the track runs perpendicular to the one of the left side and the right side, the closed position is characterized by the two wings being slid along the tracks into an interior space within the scale structure, and the open position is characterized by the two wings being slid along the tracks out of the interior space to rest along the one of the left side and the right side.

14. The scale of claim 12, wherein the track runs perpendicular to the one of the left side and the right side, the closed position is characterized by the two wings being slid along the tracks towards each other atop the scale structure, and the open position is characterized by the two wings being slid along the tracks apart from each other along the one of the left side and the right side.

15. The scale of claim 12, wherein the track runs perpendicular to the one of the left side and the right side, the closed position is characterized by the two wings being slid along the tracks into a bottom space beneath the scale structure, and the open position is characterized by the two wings being slid along the tracks out of the bottom space to rest along the one of the left side and the right side.

16. The scale of claim 1, wherein the positioning mechanism includes a springloaded opening mechanism and a closure restraint mechanism.

17. The scale of claim 1, wherein the positioning mechanism includes an activation switch that activates the scale when the two wings are moved to the open position and deactivates the scale in the closed position.

18. The scale of claim 1, wherein the data output device includes at least one of a digital display and a sound generating device.

19. The scale of claim 18, wherein the sound generating device includes voice generating means.

20. The scale of claim 18, wherein the digital display includes at least one of a light emitting diode, a liquid crystal display, and a backlight.
